(19) United States
(12) Patent Application Publication
(10) Pub. No.: US 2016/0023534 A1
(43) Pub. Date: Jan. 28, 2016

(54) IN-VEHICLE CONTROL APPARATUS

(71) Applicant: TOYOTA JIDOSHA KABUSHIKI KAISHA, Toyota-shi (JP)

(72) Inventor: Hiroto MIURA, Toyota-shi (JP)

(73) Assignee: TOYOTA JIDOSHA KABUSHIKI KAISHA, Toyota-shi (JP)

(21) Appl. No.: 14/808,382

(22) Filed: Jul. 24, 2015

(30) Foreign Application Priority Data
Jul. 25, 2014 (JP) 2014-152371

(51) Int. Cl. B60H 1/00; F02N 11/08

(52) U.S. Cl. CPC B60H 1/00735; F02N 11/0814

(57) ABSTRACT

An in-vehicle control apparatus includes a command value change unit that changes a command value for adjusting a predetermined physical quantity when an operation switch which is operated by a user is on-operated, a physical quantity detection unit that detects the predetermined physical quantity, an engine start request unit that makes a start request to an engine mounted in a vehicle so as to match the predetermined physical quantity with a physical quantity according to the command value based on the command value and the predetermined physical quantity detected by the physical quantity detection unit, a switch determination unit that determines whether the operation switch is on-operated upon starting the vehicle; and a command value setting unit that fixes the command value at a predetermined value without changing the command value when the switch determination unit determines that the operation switch is on-operated upon starting the vehicle.

### INCORPORATION BY REFERENCE

The disclosure of Japanese Patent Application No. 2014-152371 filed on Jul. 25, 2014 including the specification, drawings and abstract is incorporated herein by reference in its entirety.

### BACKGROUND OF THE INVENTION

1. Field of the Invention

The present invention relates to an in-vehicle control apparatus, and in particular, to an in-vehicle control device which changes a command value for adjusting a predetermined physical quantity when an operation switch is on-operated by a user and makes a start request to an engine mounted in a vehicle so as to match both the command value of the predetermined physical quantity and an actual value based on the command value of the predetermined physical quantity and the actual value.

2. Description of Related Art

In the related art, an in-vehicle control device which performs air conditioning according to an operation of a user is known (for example, see Japanese Patent Application Publication No. 2010-255504 (JP 2010-255504 A)). To this in-vehicle control device, a signal output from an operation switch operable by a vehicle occupant is input. The operation switch outputs an on signal for instructing to change a target air conditioning temperature when a press operation is performed by the vehicle occupant and outputs an off signal for instructing to maintain the target air conditioning temperature when the press operation is not performed. The in-vehicle control device adjusts an air conditioning temperature so as to match an actual temperature with the target air conditioning temperature while setting or changing the target air conditioning temperature according to an input signal from the operation switch. In general, the target air conditioning temperature is changed by a predetermined temperature each time the operation switch is press-operated once and is changed by a predetermined temperature at every predetermined time when the press operation is continued.

In the in-vehicle control device, when the target air conditioning temperature determined according to the operation of the operation switch is higher than the actual temperature during engine stop, in order to secure air conditioning capacity (specifically, heating capacity), a start request to the engine is made such that the temperature of engine cooling water is equal to or higher than the target air conditioning temperature. If the engine starts according to the start request, the temperature of the engine cooling water increases with the driving of the engine, and air warmed by the increase in temperature is blown out to the inside of the vehicle with the driving of a blower motor. Therefore, air conditioning capacity (specifically, heating capacity) is secured.

On the other hand, upon starting the vehicle in which power is supplied to enable the operation of the operation switch, if a failure occurs in which the operation switch continuously outputs the on signal, even though the vehicle occupant does not press-operate the operation switch, the in-vehicle control device may gradually increase or decrease the target air conditioning temperature over time. If such a situation has happened, the difference between the target air conditioning temperature and the actual temperature gradually increases immediately after starting. Accordingly, the start request to the engine is performed in a short time after starting the vehicle. For this reason, if the target air conditioning temperature is changed according to the continuation of the on signal of the operation switch in which failure has occurred upon starting the vehicle, an originally unnecessary start of the engine easily occurs.

### SUMMARY OF THE INVENTION

The invention provides an in-vehicle control device capable of suppressing an originally unnecessary start of an engine due to failure in an operation switch.

The first aspect of the invention relates to an in-vehicle control apparatus. The in-vehicle control apparatus includes a command value change unit that changes a command value for adjusting a predetermined physical quantity when an operation switch which is operated by a user is on-operated, a physical quantity detection unit that detects the predetermined physical quantity, a engine start request unit that makes a start request to an engine mounted in a vehicle so as to match the predetermined physical quantity with a physical quantity according to the command value based on the command value and the predetermined physical quantity detected by the physical quantity detection unit, a switch determination unit that determines whether the operation switch is on-operated upon starting the vehicle, and a command value setting unit that fixes the command value at a predetermined value without changing the command value by the command value change unit when the switch determination unit determines that the operation switch is on-operated upon starting the vehicle.

The second aspect of the invention relates to an in-vehicle control apparatus. The in-vehicle control apparatus includes a command value change unit that detects an operation of a switch and changes a target temperature, a physical quantity detection unit that detects a temperature, and a control unit configured to perform temperature control based on the target temperature and the temperature, wherein the control unit limits the change of the target temperature within a predetermined range when the operation of the switch is detected upon starting a vehicle.

The third aspect of the invention relates to an in-vehicle control apparatus. The in-vehicle control apparatus includes a command value change unit that changes a command value for adjusting a target temperature when an operation of an operation switch is detected, a physical quantity detection unit that detects a temperature in an interior of a vehicle, an engine start request unit that makes a start request to request the operation of an engine mounted in the vehicle so as to bring the temperature close to the target temperature based on the target temperature and the temperature, a switch determination unit that determines whether the operation switch is operated upon starting the vehicle, and a command value setting unit that limits the target temperature to a predetermined value when the switch determination unit determines that the operation switch is on-operated upon starting the vehicle.

According to the above aspects of the invention, it is possible to suppress an originally unnecessary start of an engine due to failure in an operation switch.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a configuration diagram of a system including an in-vehicle control device according to an example of the invention;

FIG. 2 is a flowchart of an example of a control routine which is executed to set an initial value of a set temperature in the in-vehicle control device of this example;

FIG. 3 is a flowchart of an example of a control routine which is executed to set a set temperature in the in-vehicle control device of this example; and

FIG. 4 is a flowchart of an example of a control routine which is executed in an HV-ECU according to a modification example of the invention.

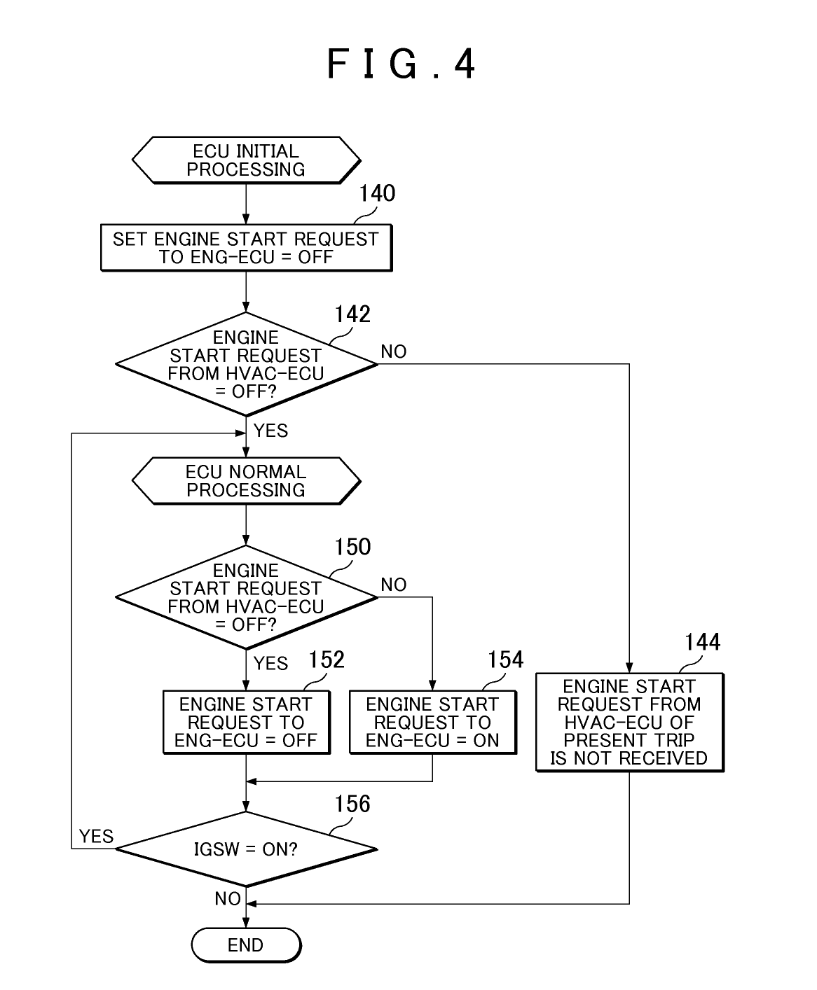

### DETAILED DESCRIPTION OF EMBODIMENTS

Hereinafter, a specific embodiment of an in-vehicle control device 10 according to the invention will be described referring to the drawings.

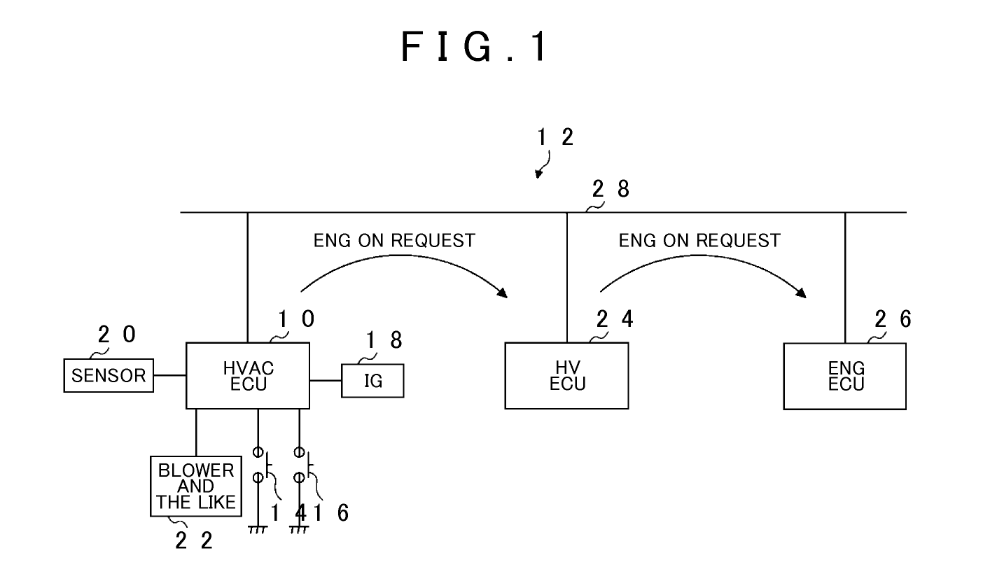

FIG. 1 is a configuration diagram of a system 12 including an in-vehicle control device 10 according to an example of the invention. The system 12 is a system which is used to control air conditioning of the inside of a vehicle, and is, for example, an in-vehicle system which is mounted in a hybrid vehicle configured to generate power by a combination of an engine, which generates power through fuel supply, and an electric mode, in which power is generated through electric power supply.

The system 12 includes an HVAC-ECU (hereinafter, referred to as an HVAC-ECU 10) as the in-vehicle control device 10. The HVAC-ECU 10 is an air conditioning computer which executes air conditioning control inside the vehicle. This air conditioning control executes air blowing, cooling and heating, dehumidifying, and the like inside the vehicle.

A +switch 14 and a −switch 16 are electrically connected to the HVAC-ECU 10. Both the +switch 14 and the −switch 16 are disposed in a front control panel or a rear control panel inside the vehicle. The +switch 14 is a temperature increase switch which is used to increase a target set temperature as a temperature inside the vehicle, and is an on/off switch which is press-operated by a vehicle occupant as a user. The −switch 16 is a temperature decrease switch which is used to decrease a target set temperature as a temperature inside the vehicle, and is an on/off switch which is press-operated by the vehicle user.

Each of the +switch 14 and the −switch 16 outputs an off signal when the press operation is not performed by the vehicle occupant, and outputs an on signal when the press operation is performed by the vehicle occupant. An output signal of the +switch 14 and an output signal of the −switch 16 are input to the HVAC-ECU 10. The HVAC-ECU 10 determines whether or not the press operation of the +switch 14 is performed by the vehicle occupant based on an input signal from the +switch 14. Also, the HVAC-ECU 10 determines whether or not the press operation of the −switch 16 is performed by the vehicle occupant based on an input signal from the −switch 16.

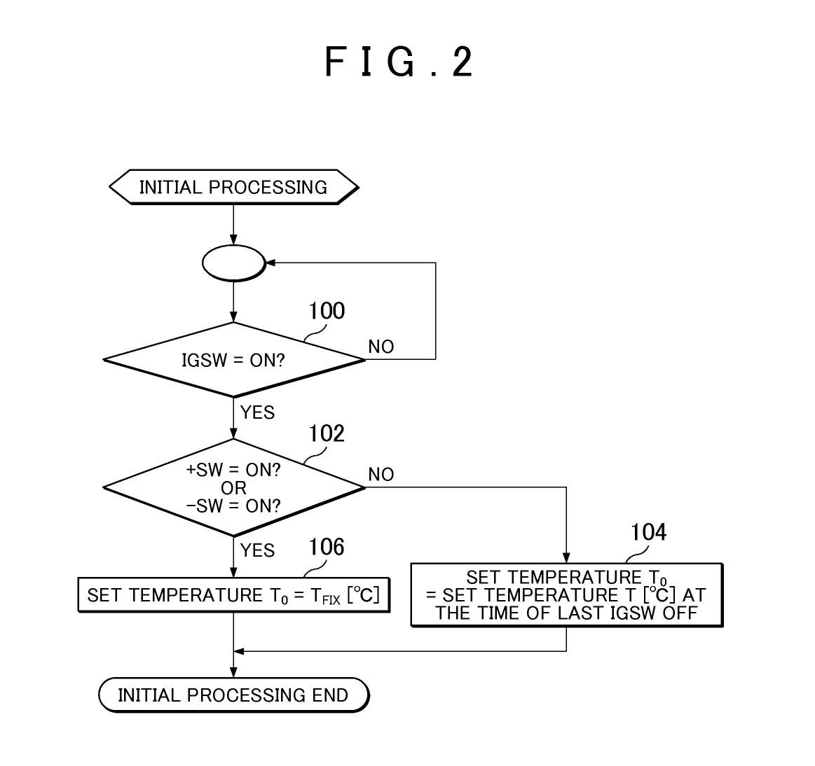

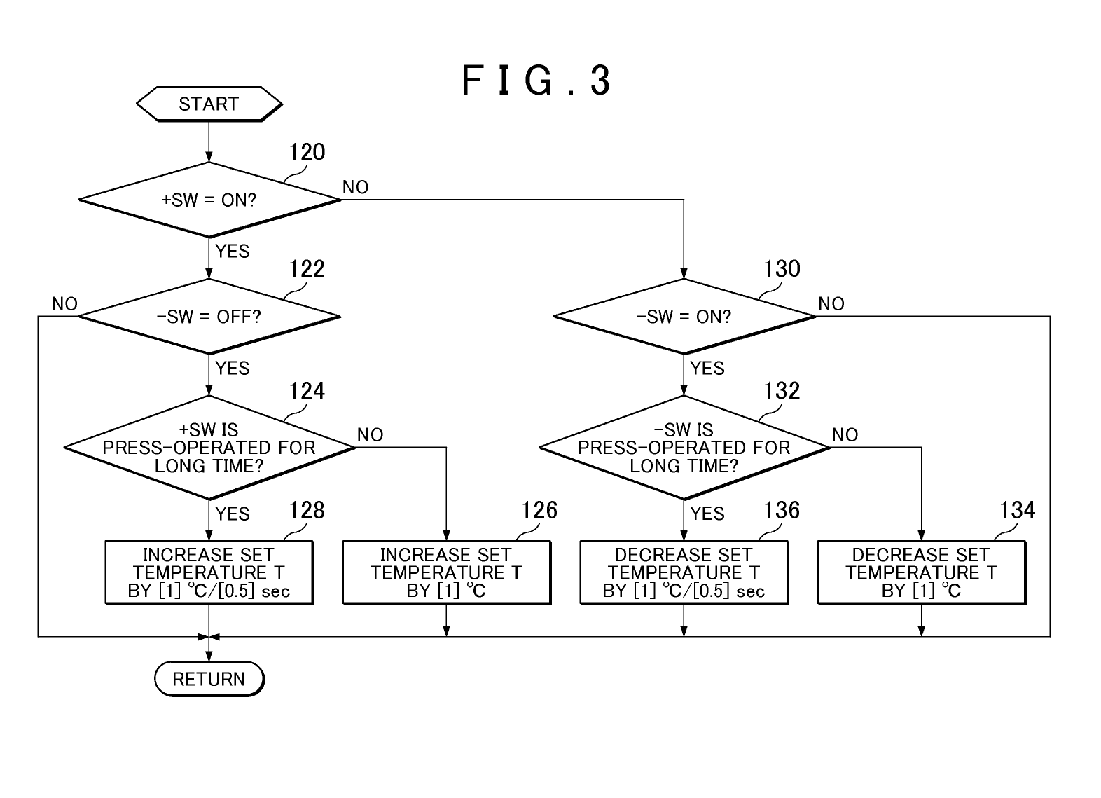

FIG. 2 is a flowchart of an example of a control routine which is executed to set an initial value of a set temperature in the HVAC-ECU 10 of this example. FIG. 3 is a flowchart of an example of a control routine which is executed to set a set temperature in the HVAC-ECU 10 of this example.

To the HVAC-ECU 10, the state of an ignition switch 18 which is one of power source positions in the vehicle is input. The HVAC-ECU 10 can determine whether the ignition switch 18 is on or off based on the input state. The HVAC-ECU 10 determines whether or not the ignition switch 18 is on (Step 100). This determination is repeatedly executed until it is determined that the ignition switch 18 is on, that is, until it is determined that the ignition switch 18 is switched from off to on.

When it is determined that the ignition switch 18 is switched from off to on, the HVAC-ECU 10 determines whether or not at least one of the +switch 14 and the −switch 16 is on-operated at the time of switching, that is, whether or not at least one of the input signal from the +switch 14 and the input signal from the −switch 16 is the on signal (Step 102).

When it is determined in Step 102 that both of the input signal from the +switch 14 and the input signal from the −switch 16 are not the on signal, the HVAC-ECU 10 sets an initial value T₀ of a target set temperature T as a vehicle interior temperature at the time of switching of the ignition switch 18 from off to on to a set temperature T′ set during last ignition off (that is, at the time of last switching of the ignition switch from on to off) (Step 104). In Step 104, if the initial value T₀ of the set temperature T is set, the HVAC-ECU 10 ends initial processing.

When it is determined in Step 102 that at least one of the input signal from the +switch 14 and the input signal from the −switch 16 is the on signal, the HVAC-ECU 10 sets the initial value T₀ of the set temperature T to a default value T_{FIX} determined in advance (Step 106). The default value T_{FIX} may be an average temperature in a country or a region where the vehicle is used, and is, for example, 25° C. The default value T_{FIX} may be the set temperature T′ at the time of last ignition off described above. The default value T_{FIX} may be a predetermined range. In Step 106, if the initial value T₀ of the set temperature T is set, the HVAC-ECU 10 ends the initial processing.

In this way, in this example, at the time of switching of the ignition switch 18 from off to on, the initial value T₀ of the set temperature T for air conditioning inside the vehicle can be set to the set temperature T′ set at the time of last ignition off when both of the input signal from the +switch 14 and the input signal from the −switch 16 are not the on signal, and can be set to the default value T_{FIX} determined in advance when at least one of the input signal from the +switch 14 and the input signal from the −switch 16 is the on signal.

When the default value T_{FIX} is set as the initial value T₀ of the set temperature T, thereafter, the set temperature T may be maintained at the initial value T₀ within a predetermined period (for example, a period during which the input signal from the +switch 14 or the −switch 16 is the on signal), and the set temperature T may be changeable from the initial value T₀ after the predetermined period elapses (for example, after the input signal from the +switch 14 or the −switch 16 is switched from the on signal to the off signal). According to this configuration, even when at least one of the input signal from the +switch 14 and the input signal from the −switch 16 is the on signal from the beginning of the start of the vehicle with the ignition switch 18 switched from off to on, the set temperature T for air conditioning inside the vehicle can be continuously fixed at the default value T_{FIX} as the initial value T₀ within the predetermined period.

In this example, the HVAC-ECU 10 sets the initial value T₀ of the set temperature T according the routine shown in FIG. 2 and then executes the following processing while the ignition switch 18 is on. Specifically, first, it is determined whether or not the input signal from the +switch 14 is the on signal (Step 120).

When it is determined in Step 120 that the input signal from the +switch 14 is the on signal, next, the HVAC-ECU 10 determines whether or not the input signal from the −switch 16 is the off signal (Step 122). As a result, when it is determined that the input signal from the −switch 16 is not the off signal, it is determined that both the +switch 14 and the −switch 16 are press-operated, and the present routine ends without advancing any processing subsequently.

When it is determined in Step 122 that the input signal from the −switch 16 is the off signal, the HVAC-ECU 10 determines that only the +switch 14 is press-operated, and next, determines whether or not the +switch 14 is press-operated for a long time (Step 124). This determination becomes affirmative when the press operation of the +switch 14 is continued for a predetermined time or more (for example, 0.5 seconds or the like) from the start.

When it is determined in Step 124 that the +switch 14 is not press-operated for a long time, the HVAC-ECU 10 determines that the +switch 14 is operated for a short time, and performs processing for increasing the set temperature T of the vehicle interior temperature by a predetermined temperature ΔT (for example, 1° C. or the like) (Step 126). When it is determined in Step 124 that the +switch 14 is press-operated for a long time, the HVAC-ECU 10 performs processing for increasing the set temperature T of the vehicle interior temperature by a predetermined temperature ΔT (for example, 1° C. or the like) each time the press operation of the +switch 14 is continued for a predetermined time (for example, 0.5 seconds or the like) (Step 128).

When it is determined in Step 120 that the input signal from the +switch 14 is not the on signal, next, the HVAC-ECU 10 determines whether or not the input signal from the −switch 16 is the on signal (Step 130). As a result, when it is determined that the input signal from the −switch 16 is not the on signal, it is determined that both the +switch 14 and the −switch 16 are not press-operated, and the present routine ends without advancing any processing subsequently.

When it is determined in Step 130 that the input signal from the −switch 16 is the on signal, the HVAC-ECU 10 determines that only the −switch 16 is press-operated, and next, determines whether or not the −switch 16 is press-operated for a long time (Step 132). This determination becomes affirmative when the press operation of the −switch 16 is continued for a predetermined time or more (for example, 0.5 seconds or the like) from the start.

When it is determined in Step 132 that the −switch 16 is not press-operated for a long time, the HVAC-ECU 10 determines that the −switch 16 is press-operated for a short time, and performs processing for decreasing the set temperature T of the vehicle interior temperature by a predetermined temperature ΔT (for example, 1° C. or the like) (Step 134). When it is determined in Step 132 that the −switch 16 is press-operated for a long time, the HVAC-ECU 10 performs processing for decreasing the set temperature T of the vehicle interior temperature by a predetermined temperature ΔT (for example, 1° C. or the like) each time the press operation of the −switch 16 is continued for a predetermined time (for example, 0.5 seconds or the like) (Step 136).

In this way, in this example, while the ignition switch 18 is on, the set temperature T for air conditioning inside the vehicle can be increased according to the press operation of the +switch 14 and can be decreased according to the press operation of the −switch 16. Specifically, the set temperature T can be increased by the predetermined temperature ΔT when the +switch 14 is press-operated for a short time, can be increased by the predetermined temperature ΔT for every predetermined time when the +switch 14 is press-operated for a long time, can be decreased by the predetermined temperature ΔT when the −switch 16 is press-operated for a short time, and can be decreased by the predetermined temperature ΔT for every predetermined time when the −switch 16 is press-operated for a long time.

In this example, to the HVAC-ECU 10, various sensors 20 are electrically connected. Various sensors 20 are an inside air sensor which outputs a signal according to a temperature or a humidity inside the vehicle, an outside air temperature sensor which outputs a signal according to an outside air temperature, a solar radiation sensor which outputs a signal according to the amount of solar radiation, and the like. Output signals of the sensors 20 are input to the HVAC-ECU 10. The HVAC-ECU 10 detects data including at least the vehicle interior temperature necessary for performing air conditioning control inside the vehicle based on input signals from the sensors 20.

To the HVAC-ECU 10, a blower and the like 22 is electrically connected. The blower and the like 22 is an actuator which is driven for controlling air conditioning inside the vehicle, and is a blower motor and the like. The HVAC-ECU 10 executes control for air conditioning inside the vehicle so as to match the vehicle interior temperature with the set temperature T based on the set temperature T for air conditioning inside the vehicle set in the above-described manner and various kinds of data detected based on the input signals from the sensors 20, and drives the blower and the like 22.

For example, when the set temperature T for air conditioning inside the vehicle is higher than the actual temperature inside the vehicle, the HVAC-ECU 10 executes heating control as control for air conditioning inside the vehicle such that the vehicle interior temperature matches the set temperature T. When the set temperature T for air conditioning inside the vehicle is lower than the actual temperature inside the vehicle, the HVAC-ECU 10 executes cooling control as control for air conditioning inside the vehicle so as to match the vehicle interior temperature with the set temperature T.

In the heating control for air conditioning inside the vehicle, air inside the vehicle or taken from the outside of the vehicle is warmed by heat received from engine cooling water which increases in temperature by cooling the engine, and is then blown out to the inside of the vehicle by the driving of the blower motor. In the cooling control for air conditioning inside the vehicle, air inside the vehicle or taken from the outside of the vehicle is cooled by a circulation cycle of a refrigerant using a compressor, and is then blown out to the inside of the vehicle by the driving of the blower motor.

To the HVAC-ECU 10, an HV-ECU 24 and an ENG-ECU 26 are connected through an intra-vehicle LAN 28. The HV-ECU 24 is a hybrid control computer which performs control for drive power distribution or the like of the engine and an electric motor of the hybrid vehicle. The ENG-ECU 26 is an engine control computer which controls the driving of the engine mounted in the hybrid vehicle. The intra-vehicle LAN 28 is, for example, a control area network (CAN) which can perform data communication according to a predetermined communication protocol in the hybrid vehicle.

The HVAC-ECU 10 sends a signal for requesting the start of the engine to the HV-ECU 24 toward the intra-vehicle LAN 28 in order to secure a heat source of heating when executing heating control during engine stop. If the signal for requesting the start of the engine from the HVAC-ECU 10 is received through the intra-vehicle LAN 28, the HV-ECU 24 sends a signal for requesting the start of the engine to the ENG-ECU 26 toward the intra-vehicle LAN 28. If the signal for requesting the start of the engine from the HV-ECU 24 is received through the intra-vehicle LAN 28, the ENG-ECU 26 starts the engine.

If the engine is started, engine cooling water increases in temperatures, air inside the vehicle or taken from the outside of the vehicle is warmed by the increase in temperature, and warmed air is blown out to the inside of the vehicle by the driving of the blower motor. Accordingly, when the set temperature T for air conditioning inside the vehicle is higher than the actual temperature inside the vehicle while the engine of the hybrid vehicle is stopped, the engine is forcibly started, whereby the heat source of heating can be secured, and thus, heating control according to the set temperature T can be executed.

In this example, as described above, when at least one of the input signal from the +switch 14 and the input signal from the −switch 16 is the on signal at the time of switching of the ignition switch 18 from off to on, the initial value T₀ of the set temperature T for air conditioning inside the vehicle is set to the default value T_{FIX}, and thereafter, the set temperature T is fixed at the default value T_{FIX} within a predetermined period (for example, a period during which the on signal is continued).

According to this configuration, when at least one of the input signal from the +switch 14 and the input signal from the −switch 16 is the on signal at the time of starting of the vehicle with the ignition switch 18 switched from off to on, thereafter, a situation in which the set temperature T for air conditioning inside the vehicle is changed according to the on input signal from the +switch 14 or the −switch 16 can be avoided within a predetermined period. For this reason, according to this example, when a failure occurs in which at least one of the +switch 14 and the −switch 16 continuously outputs the on signal immediately after starting with the ignition switch 18 switched from off to on, a situation in which the difference between the set temperature T and the actual temperature gradually increases due to the continuation of the on signal is avoided.

Therefore, according to the in-vehicle control device 10 of this example, when a failure occurs in which the +switch 14 continuously outputs the on signal at the time of starting, it is possible to inhibit a start request to the engine in a short time after starting, and to suppress an originally unnecessary start of the engine due to the failure. For this reason, it is possible to prevent deterioration of exhaust emission according to engine start when a failure occurs in which the +switch 14 continuously outputs the on signal.

According to the in-vehicle control device 10 of this example, when a failure occurs in which at least one of the +switch 14 and the −switch 16 continuously outputs the on signal, it is possible to avoid a situation in which air conditioning control reaches an extreme control state according to the on input signal. For this reason, it is possible to prevent the vehicle occupant from feeling a sense of discomfort due to air conditioning inside the vehicle when a failure occurs in which the +switch 14 or the −switch 16 continuously outputs the on signal.

In the above-described example, the vehicle interior temperature corresponds to “predetermined physical quantity”, the +switch 14 and the −switch 16 correspond to “operation switch”, the HVAC-ECU 10 executing the processing of Step 102 in the routine shown in FIG. 2 corresponds to “switch determination unit”, the HVAC-ECU 10 executing the processing of Steps 104 and 106 corresponds to “command value setting unit”, the HVAC-ECU 10 executing the processing of Steps 126, 128, 134, and 136 in the routine shown in FIG. 3 corresponds to “command value change unit”, the HVAC-ECU 10 detecting the vehicle interior temperature based on the input signal from the sensors 20 corresponds to “physical quantity detection unit”, the HVAC-ECU 10 making a start request to the engine through the HV-ECU 24 and the ENG-ECU 26 in order to secure a heat source of heating when executing heating control during engine stop corresponds to “engine start request unit”.

On the other hand, in the above-described example, when at least one of the input signal from the +switch 14 and the input signal from the −switch 16 is the on signal at the time of starting of the vehicle with the ignition switch 18 switched from off to on, thereafter, the HVAC-ECU 10 fixes the set temperature T for air conditioning inside the vehicle at the default value T_{FIX} within a predetermined period (for example, a period during which the on signal is continued), and inhibits a start request to the engine in a short time after starting.

However, the inhibition of a start request to the engine in a short time after starting the vehicle is not limited thereto. For example, even when at least one of the input signal from the +switch 14 and the input signal from the −switch 16 is the on signal at the time of starting with the ignition switch 18 switched from off to on, as normal, the HVAC-ECU 10 changes the set temperature T for air conditioning inside the vehicle according to the on input signal, and then, the HV-ECU 24 may not receive an engine start request from the HVAC-ECU 10 and may not make an engine start request to the ENG-ECU 26 within a predetermined period after starting with the ignition switch 18 switched from off to on.

Specifically, in this modification example, when it is determined that the ignition switch 18 is changed from off to on, first, the HV-ECU 24 sets an engine start request signal to the ENG-ECU 26 to off (Step 140). Next, immediately after starting with the ignition switch 18 switched from off to on, it is determined whether or not an engine start request signal from the HVAC-ECU 10 is off (Step 142). As a result, when it is determined that the engine start request signal from the HVAC-ECU 10 is not off, that is, on, immediately after starting, the engine start request from the HVAC-ECU 10 in a present trip during which the ignition switch 18 is continuously on is not received (Step 144).

When it is determined in Step 142 that the engine start request signal from the HVAC-ECU 10 is off immediately after starting, thereafter, the HV-ECU 24 performs normal processing. Specifically, it is determined whether or not the engine start request signal from the HVAC-ECU 10 is off (Step 150). As a result, when it is determined that the engine start request signal from the HVAC-ECU 10 is off, the engine start request signal to the ENG-ECU 26 is off (Step 152). When it is determined that the engine start request signal from the HVAC-ECU 10 is on, the engine start request signal to the ENG-ECU 26 is on (Step 154). The HV-ECU 24 continuously the normal processing in a period during which the ignition switch 18 is on (when the determination in Step 156 is affirmative), and ends the normal processing when the ignition switch 18 is off (when the determination in Step 156 is negative).

In the configuration of this modification example, even when there is the engine start request from the HVAC-ECU 10 to the HV-ECU 24 immediately after starting the vehicle with the ignition switch 18 switched from off to on, the HV-ECU 24 does not make a start request to the engine. That is, when a failure occurs in which the +switch 14 continuously outputs the on signal at the time of starting, even if the HVAC-ECU 10 changes the set temperature T for air conditioning inside the vehicle according to the on input signal of the +switch 14 immediately after starting to give an engine start request toward the HV-ECU 24, the HV-ECU 24 does not receive the engine start request and does not make a start request to the engine.

Therefore, according to this modification example, it is possible to suppress an originally unnecessary start of the engine due to a failure that the +switch 14 continuously outputs the on signal at the time of starting with the ignition switch 18 switched from off to on. For this reason, it is possible to prevent deterioration of exhaust emission according to engine start when a failure occurs in which the +switch 14 continuously outputs the on signal.

In the above-described example, the set temperature T for air conditioning inside the vehicle is used as a physical quantity which is adjustable by the operation of the user. However, the invention is not limited thereto, and a physical quantity which is adjustable by an operation of a user and serves as a parameter for control to start the engine based on the command value of the physical quantity and an actual value may be used.

What is claimed is:

1. An in-vehicle control apparatus comprising:
a command value change unit that changes a command value for adjusting a predetermined physical quantity when an operation switch which is operated by a user is on-operated;
a physical quantity detection unit that detects the predetermined physical quantity;
a engine start request unit that makes a start request to an engine mounted in a vehicle so as to match the predetermined physical quantity with a physical quantity according to the command value based on the command value and the predetermined physical quantity detected by the physical quantity detection unit;
a switch determination unit that determines whether the operation switch is on-operated upon starting the vehicle; and
a command value setting unit that fixes the command value at a predetermined value without changing the command value by the command value change unit when the switch determination unit determines that the operation switch is on-operated upon starting the vehicle.

2. The in-vehicle control apparatus according to claim 1,
wherein the command value setting unit sets an initial value of the command value to a last command value set at a last end when the switch determination unit determines that the operation switch is not on-operated upon starting the vehicle.

3. The in-vehicle control apparatus according to claim 1,
wherein the predetermined physical quantity is a temperature, and the operation switch is an air conditioning temperature change switch.

4. The in-vehicle control apparatus according to claim 1,
wherein the switch determination unit determines whether the operation switch is on-operated when an ignition switch is switched from off to on.

5. An in-vehicle control apparatus comprising:
a command value change unit that detects an operation of a switch and changes a target temperature;
a physical quantity detection unit that detects a temperature; and
a control unit configured to perform temperature control based on the target temperature and the temperature, wherein
the control unit limits the change of the target temperature within a predetermined range when the operation of the switch is detected upon starting a vehicle.

6. An in-vehicle control apparatus comprising:
a command value change unit that changes a command value for adjusting a target temperature when an operation of an operation switch is detected;
a physical quantity detection unit that detects a temperature in an interior of a vehicle;
an engine start request unit that makes a start request to request the operation of an engine mounted in the vehicle so as to bring the temperature close to the target temperature based on the target temperature and the temperature;
a switch determination unit that determines whether the operation switch is operated upon starting the vehicle; and
a command value setting unit that limits the target temperature to a predetermined value when the switch determination unit determines that the operation switch is on-operated upon starting the vehicle.
